(19) United States
(12) Patent Application Publication
(10) Pub. No.: US 2019/0087765 A1
(43) Pub. Date: Mar. 21, 2019

(54) METHOD AND SYSTEM FOR VALUE ASSESSMENT OF A MEDICAL CARE PROVIDER

(71) Applicant: International Business Machines Corporation, Armonk, NY (US)

(72) Inventors: Amy G. Brown, Carmel, IN (US); Alice Huang, Chicago, IL (US)

(21) Appl. No.: 15/710,335

(22) Filed: Sep. 20, 2017

(51) Int. Cl. G06Q 10/06; G06F 19/00; G06Q 50/22

(52) U.S. Cl. CPC G06Q 10/06395; G06Q 50/22; G06F 19/327; G06Q 10/06398

(57) ABSTRACT

A method of assessing provider care metrics for use in a healthcare analytics management system is disclosed. The method comprises identifying a medical care provider for performance review of a care term and generating a classification for the provider indicating a peer group. The method further comprises receiving, by a processor, class patient data associated with the classification. The class patient data comprising a plurality of care factors. The processor identifies care determinative factors from the plurality of care factors and calculates an optimum care performance for the provider balancing a care cost and a care quality for the care determinative factors. The processor further compares a provider performance of the medical care provider during the care term to the optimum care performance and generates a provider score indicating a comparison of the provider performance to the peer group.

### BACKGROUND

The present invention relates to a system and method for assessing employee performance, and more specifically, to a method for improving an operation of a system to accurately assess the performance of health care professionals.

### SUMMARY

According to an embodiment of the present invention, a method of assessing provider care metrics for use in a healthcare analytics management system is disclosed. The method comprises identifying a medical care provider for performance review of a care term and generating a classification for the provider indicating a peer group. The method further comprises receiving, by a processor, class patient data associated with the classification. The class patient data comprises a plurality of care factors. The processor identifies care determinative factors from the plurality of care factors and calculates an optimum care performance for the provider balancing a care cost and a care quality for the care determinative factors. The processor further compares a provider performance of the medical care provider during the care term to the optimum care performance and generates a provider score indicating a comparison of the provider performance to the peer group.

According to another embodiment of the present invention, a computer program product for identifying a comparative level of patient care for a care provider is disclosed. The computer program product comprises a computer readable storage medium having program instructions embodied therewith. The program instructions are executable by a processor and cause the processor to generate a classification with the processor for the care provider indicating a peer group. The peer group identifies a medical specialty field in which the care provider practices. The processor then receives or accesses class patient data associated with the classification. The class patient data comprises a plurality of care factors including care factor values quantifying the care factors for each of a plurality of patients of the patient data. Based on the instructions, the processor further identifies care determinative factors from the plurality of care factors and calculates an optimum care performance for the provider balancing a care cost and a care quality for the care determinative factors. The processor then compares a provider performance of the medical care provider during the care term to the optimum care performance and generates a provider score indicating a comparison of the provider performance to the peer group.

According to yet another embodiment of the present invention, a method of assessing provider care metrics for use in a healthcare analytics management system is disclosed. The method comprises identifying a medical care provider for performance review of a care term and generating a classification for the medical care provider indicating a peer group. The method further comprises receiving, by a processor, class patient data associated with the classification, the class patient data comprising a plurality of care factors and identifying care determinative factors from the plurality of care factors. The identifying of the care determinative factors comprises first filtering the care factors, by the processor, based on a minimum variation generating first filtered factors and second filtering the care factors, by the processor generating care determinative factors. The second filtering is based on a correlation between the plurality of care factors and at least one activity attributed to the medical care provider. The method further comprises calculating, by the processor, an optimum care performance for the provider balancing a care cost and a care quality for the care determinative factors.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a process diagram demonstrating a method for assessing provider care metrics for a medical care provider;

FIG. 2 is a block diagram of a system for assessing provider care metrics for a medical care provider;

FIG. 3 is a flowchart of a method for identifying a classification for a medical care provider;

FIG. 4 is a flowchart demonstrating a process for identifying a plurality of care determinative factors that have a correlation to activities of a medical care provider; and

FIG. 5 is a flowchart demonstrating a method for calculating a score assessing a quality and cost of care provided by a medical care provider in accordance with the disclosure.

### DETAILED DESCRIPTION

The disclosure provides for a system and method for value measurement of a medical care provider (e.g., a physician, medical professional, nurse, etc.). The methods and systems disclosed herein evaluate the medical care provider based on care determinative factors, which may be determined from a variety of care factors related to patient care. In order to identify the care determinative factors that can be associated with the medical care provider, in some embodiments, the disclosure may provide for a filtering and selection process identifying the care determinative factors. The care determinative factors may be identified from a multitude of care factors that may relate to financial factors indicated by expenses related to patient care, quality factors indicated by patient satisfaction and treatment outcomes, patient and community socioeconomic factors indicated by various economic and sociological metrics, etc. By utilizing and sampling patient data including a wide variety of care factors, the disclosure may provide for improved accuracy in assessing the performance of medical care providers by considering a variety of real-world factors isolating those that can be attributed to the performance of the medical care provider.

Once the care determinative factors are identified from the plurality of care factors, the methods and systems described herein may continue to calculate an optimum care performance for the medical care provider by balancing a care cost and a care quality for each of the care determinative factors. The balance of the cost and quality of care may be determined based on a Data Envelopment Analysis (DEA) of the care determinative factors. DEA may utilize the care determinative factors as inputs and calculate the optimum balance between the cost of care and quality of care for each of the care determinative factors. The optimum balance of the care determinative factors may correspond to optimum performance criteria to which the medical care provider may be compared in order to assess his or her performance. In addition to DEA, the disclosure may further provide for a simulation process (i.e., a Monte Carlo simulation) configured to normalize or adjust variations among samples of the care factors in order to ensure that the medical care provider is assessed on patient data during a care term that closely resembles the patient data of the medical care provider being assessed. In this way, the methods discussed herein may provide for improved accuracy when assessing the medical care provider by ensuring that the provider is evaluated based on like conditions to those practicing in the same field.

The various embodiments of the disclosure provide for particularly beneficial improvements to conventional performance assessment determinations and metrics. For example, the combination of filtering the care factors that can be associated with the activities and performance of the medical care provider provides benefits including improving computational efficiency of the provider score as well as ensuring that low variation factors having minimal relation to performance are filtered from the assessment. Additionally, the one or more filtering steps may work in combination with the DEA to ensure that the care factors analyzed are limited to those that can be associated with the performance of the medical care provider rather than outlying factors that may otherwise skew the assessment based on extrinsic factors outside the control of the medical care provider. In this way, the methods and systems described herein provide for improved accuracy and efficiency in determining the assessment or provider score of the medical care provider.

In some embodiments, the one of more filtering steps in combination with the DEA analysis may further be improved by the simulation process. Both the DEA as well as the simulation may be utilized by the methods and systems discussed herein to achieve results not otherwise possible from conventional assessments. The methods provided herein provide for accurate simulations operable to objectively model a wide variety of variables to achieve accurate models of quality and cost for the medical care provider in relation to a peer group of medical professionals. Based on the simulation, the peer group for comparison may not only be practicing in a similar medical specialty but also with similar patients in similar socioeconomic conditions. Such accuracy, both in correlation to the medical care provider's actions as well as being based on similar extrinsic circumstances, has not previously been provided by an assessment method for medical care providers. Accordingly, the methods and systems discussed herein provide for optimum steps to provide specific processes to accurately identify a provider score for the medical care provider.

The results of the assessments or provider score discussed herein may be utilized by health care organizations or administrators to evaluate medical care providers. The accuracy of the provider score determined by the disclosed methods and systems may provide for improved accuracy and tracking of performance to make accurate organizational decisions. Organizational decisions may include income assessments, promotion determinations, training or educational determinations, or various other determinations related to the assessment of the medical care provider. Not only do the methods and systems provide for accurate assessment by ensuring similar circumstances for medical providers, the provider score may further include a number of leading factors or care determinative factors demonstrating the particular strengths and weaknesses of each medical care provider based on an impartial and objective scoring system. Particular embodiments of the systems and methods are now discussed in reference to the figures.

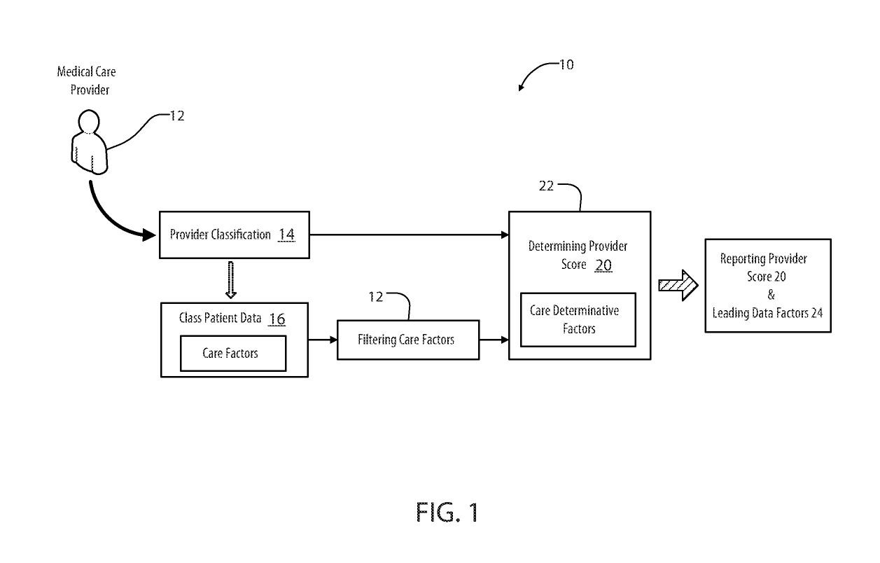

Referring to FIG. 1, a process diagram demonstrating a method 10 for assessing a medical care provider 12 is shown. The method 10 demonstrates a simplified overview of a number of steps or routines that may be utilized to assess the performance of the medical care provider 12. Each of the steps, processes, and/or routines described in reference to FIG. 1 is further described in the following detailed description. In general, the method 10 may begin by generating or identifying a provider classification 14 for the medical care provider 12. The provider classification 14 may include an indication of a specific peer group of like or similar medical care providers to which the medical care provider 12 may be compared. In some instances, the provider classification 14 may comprise a medical treatment specialty, indication of patient need severity, and other identifying factors that may ensure that the medical care provider 12 is only compared to peers practicing under similar circumstances. For example, by classifying the medical care provider 12 by the patient need severity of the patients treated, the method 10 may ensure that the medical care provider 12 is compared only to other providers who treat patients having a similar health level or, conversely, a similar treatment need level. Factors, such as comorbidity indices, may be utilized as indicators to identify the patient need severity to improve the classification of the medical care provider 12 for the peer group 40.

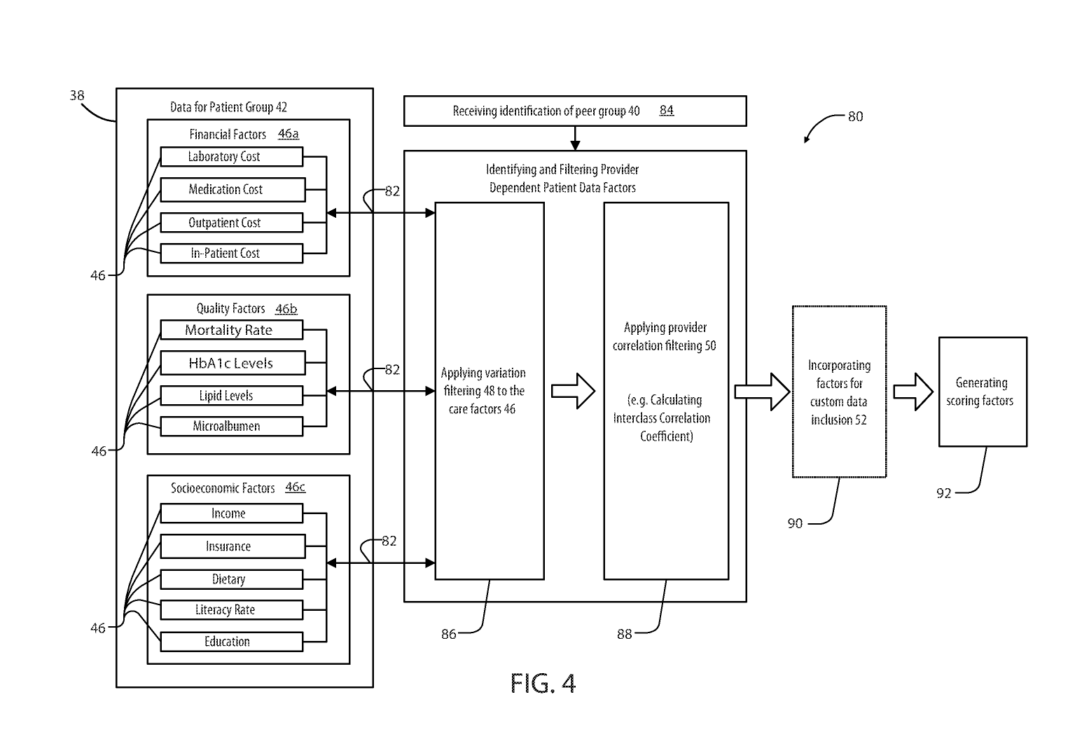

Once the classification for the medical care provider 12 is identified, class patient data 16 may be gathered for medical care providers in the peer group 40 and corresponding patients. The class patient data 16 may comprise a wide range of data that may be related to a health level, income or socioeconomic status, and related expenses associated with the care of each of the patients. Each of the factors of the class patient data 16 may be referred to herein as care factors, which may be utilized to assess the performance of the care provider 12 over an assessment period or care term. Further discussion of the provider care factors 46 and their role in the assessment process is discussed in detail in reference to FIG. 4.

Once the class patient data 16 has been gathered, the method may continue by filtering the care factors 18 of the patient data 16 to identify a subset of factors that may be attributed to the performance of the medical care provider 12 to identify the provider care factors. Such factors may be described herein as care determinative factors. Next, the process 10 may continue by determining a provider score 20 based on the care determinative factors. In some embodiments, the provider's score 20 may be calculated based on a peer comparison of sample values from the care determinative factors of the class patient data 16.

For example, the linear comparison of the sample values may comprise a DEA of the care determinative factors in order to identify optimum values for each of the care determinative factors. The optimum values from the DEA may provide for an objective or impartial determination of the optimum performance criteria for comparison to the performance of the medical care provider 12. Once the provider score 20 is calculated, the method 10 may continue by reporting the provider score 20 and additional factors or leading data factors 24, which may otherwise attribute to the performance of the medical care provider 12. As further discussed in the following detailed description, the disclosure may provide for an improved method which may provide for enhanced accuracy and optimized performance to effectively assess care metrics associated with the medical care provider 12.

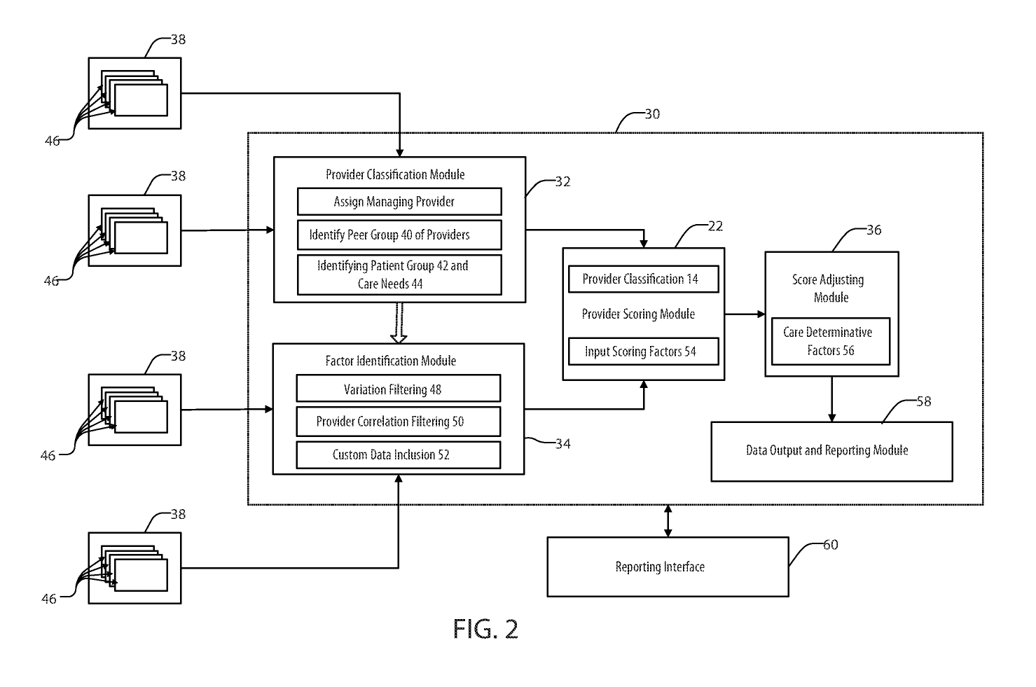

Referring to FIG. 2, a block diagram of a system 30 for assessing provider care metrics for the medical care provider 12 is shown. The system 30 may comprise a plurality of processing modules, which may correspond to one or more microprocessors or computational processing units configured to efficiently interact to generate the provider score 20. In general, the system 30 may comprise a provider classification module 32, a factor identification module 34, the scoring module 22, and a score adjusting module 36. The provider classification module 32 may be in communication with one or more information databases 38, which may be in communication with the provider classification module 32 by a network and/or internet based connection.

In operation, the provider classification module 32 may be configured to access information related to the medical care provider 12, which may include a peer group 40 of medical professionals having similar patients and practice specialties to the medical care provider 12. By accessing the one or more information databases 38, the provider classification module 32 may assign a specific practitioner as a managing provider or the medical care provider 12 overseeing the care of a patient group 42 having corresponding care needs 44. With this information, the provider classification module 32 may identify specific characteristics of the medical care provider 12 and the patient group 42 in order to identify the peer group 40 of providers for a comparative performance assessment.

The factor identification module 34 may also be in communication with one or more of the information databases 38. The factor identification module 34 may be configured to access a variety of care factors 46 and filter the care factors 46 in order to identify factors that may have a strong correlation to the activities of the medical care provider 12. These factors identified by the factor identification module 34 may later be utilized as inputs to the scoring module 22. In operation, the factor identification module 34 may process the patient data 16 of the care factors 46 by a variation filtering 48 to determine each of the care factors 46 having sufficient variation to provide meaningful variation to the provider scoring module 22. Such factors may be described as first filtered factors.

The factor identification module 34 may further process the care factors 46 by a provider correlation filtering 50 to identify whether the actions of the medical care provider 12 in relation to each of the care factors 46 can be associated with a quality or financial outcome of patient care. These factors may be described as second filtered factors. Additionally, in some embodiments, the factor identification module 34 may also be configured to incorporate one or more factors of interest via a custom data inclusion 52 incorporating care factors 46 that may otherwise be filtered by the filtering steps 48 and/or 50. Accordingly, the disclosure may provide for a flexible solution to accurately identify the care factors 46 that can be attributed to the activities of the medical care provider 12.

The factor identification module 34 may also be configured to identify redundant variables in order to further filter the care factors 46. Redundant variables may include care factors 46 that have a high level of correlation to each other. For example, a first care factor and a second care factor of the plurality of care factors may be analyzed by the factor identification module 34 to determine if the data of each of the first and second care factors have a high correlation. The level of correlation or correlation ratio considered to be high may be customized or adjusted based on a particular data set. However, a correlation ratio of 0.6 or higher may be considered to correspond to a high level as discussed herein.

The level of correlation of the care factors 46 may be identified by assessing pairwise variable correlation of the first care factor and the second care factor. If the first care factor and the second care factor are highly correlated, the factor identification module 34 may remove one of the first or the second care factor from the care factors 46. The removal of highly correlated care factors may be beneficial to limit the inclusion of variables or factors that measure the same or similar aspects of patient care. Accordingly, the factor identification module 34 may be configured to remove one or more highly correlated care factors to maximize degrees of freedom without losing too much information.

The system 30 further comprises the provider scoring module 22. The provider scoring module 22 may receive the provider classification 14 from the provider classification module 32 and may further receive input scoring factors 54, including the care factors 46 and associated patient data 16 that pass the variation filtering 48 and the provider correlation filtering 50 from the factor identification module 34. With the provider classification 14 and the input scoring factors 54, the provider scoring module 22 may calculate the provider score 20 via a DEA technique. DEA calculated by the provider scoring module 22 may analyze the input scoring factors 54 and identify a plurality of care determinative factors 56, which may be optimized by the medical care provider 12 to ensure an optimum care performance.

Based on the care determinative factors 56, the provider score 20 may be calculated by the provider scoring module 22. The provider score 20 may then be passed to the score adjusting module 36 where the patient data 16 for the patient group 42 may be compared to the patient data 16 from the peer group 40 and adjusted via a simulation process to ensure that the medical care provider 12 is compared to medical professionals in the same or similar circumstances.

The score adjusting module 36 may correct the provider score 20 and output the provider score 20 to a data output and reporting module 58. The data output and reporting module 58 may be configured to generate a number of reports, which may comprise the provider score 20 as well as the leading data factors 24 of the care determinative factors 56 that have the greatest impact on the provider score 20. The data output and reporting module 58 may further be in communication with a reporting interface 60, which may comprise a user interface configured to communicate the results from the data output and reporting module 58. In this configuration, the system 30 may access the information databases 38 and control the operation of each of the provider classification module 32, the factor identification module 34, and the provider scoring module 22 to efficiently process and output the provider score 20.

Based on the care determinative factors 56 as well as the provider score 20, health care organizations or administrators evaluating the medical care provider 12 may accurately make a number of organizational or management decisions. Such decisions may include, but are not limited to, income assessments, promotion determinations, training or educational determinations, or various other determinations related to the assessment of the medical care provider. Such management decisions may not only be based on accurate, objective analysis provided by the provider score 20 but also may be updated for a care term providing frequently updated results not available from conventional performance review methods. Accordingly, the disclosure may provide for an impartial, data driven assessment of the medical care provider 12 that may be frequently updated to by the system 30 to determine performance changes over time.

The information databases 38 may be one or more computers or network filing systems in communication with the system 30. The information databases 38 may be communicatively connected to the system 30 via a network representing a worldwide collection of networks and gateways that may use the Transmission Control Protocol/Internet Protocol (TCP/IP) suite of protocols to communicate with one another. In some embodiments, the data processing of the system 30 may be implemented as a number of different types of networks, such as for example, an intranet, a local area network (LAN), or a wide area network (WAN).

The class patient data 16 as well as data related to the financial factors 46a, quality factors 46b, and/or socioeconomic factors 46c may be accessed by the system 30 via the network. Accordingly, the information databases 38 may comprise a variety of databases related to health records as well as financial records of associated hospitals and laboratories related to the medical professionals being assessed. Additionally, the information databases 38 may comprise community information providing for an estimate of the socioeconomic conditions of the patients treated by the medical professionals. In this way, the system 30 may be operable to distinguish between conditions that can be associated with the performance of the medical care provider 12 and the effects that may be associated with socioeconomic factors 46c and other factors that may attribute to patient care.

In general, the system 30 may access data for the quality factors 46b based on patient data 16 comprising demographic data, family health history data, vital signs, laboratory test results, drug treatment history, admission-discharge-treatment (ADT) records, co-morbidities, modality images, genetic data, and other patient data. The financial factors 46a may be accessed by the system 30 by comparing patient cost for various procedures, laboratory tests, office visits, etc., which may be accessed by a variety of hospital financial databases and insurance databases. The socioeconomic factors 46c may be accessed in one of more databases including those maintained by the National Library of Medicine, the National Institute of Health, the National Center for Health Statistics, national or governmental survey data, Nielsen data collections, insurance databases, etc. Accordingly, the system 30 may be operable to access a wide variety of information related to the medical care provider 12 and the peer group 40 in order to accurately assess the performance of the medical care provider 12.

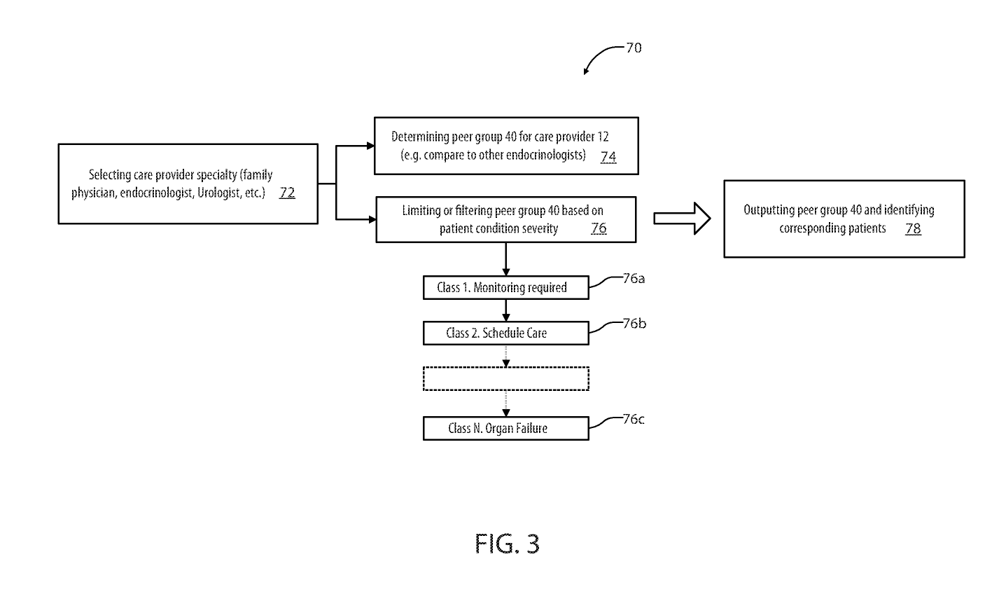

Referring now to FIG. 3, a flowchart demonstrating a method 70 for identifying the provider classification 14 is shown. The method 70 may begin by receiving or selecting a care provider specialty for the medical care provider 12 (72). For example, medical professionals may work in a variety of specific fields of practice. Accordingly, the method 70 may select the provider specialty in order to ensure that the medical care provider 12 is scored and compared only to medical professionals having the same or similar specialty. For example, a family physician may be compared to other family physicians. Additionally, more specific practice fields (e.g., endocrinologists, urologists, etc.) may be compared to medical professionals having the same specialty. As discussed later in reference to FIG. 4, the provider classification 14 may be utilized by the factor identification module 34 to process the care factors 46 from the databases 38 to identify the input scoring factors 54.

With the care provider specialty identified in step 72, the method 70 may continue by determining the peer group 40 that will be compared to the medical care provider 12 to determine the provider score 20 (74). For example, if the medical care provider 12 is identified to be an endocrinologist in step 72, the provider classification module 32 may access the information database 38 to identify the peer group 40 as other physicians with a specialty in endocrinology.

In addition to determining the peer group 40 identified for the medical care provider 12, the method 70 may continue by limiting the peer group 40 based on a stage of a condition or patient condition severity (76). For example, medical professionals in each peer group 40 may specialize in different stages of patient care. For example, some patients may only be in a stage of treatment where monitoring is required (76a). Additionally, some medical professionals in the peer group 40 may focus their practice on patients requiring scheduled care (76b). Additionally, medical professionals in the peer group 40 may treat patients having severe conditions, some of which may include organ failure and other critical care conditions (76c). Accordingly, the method 70 may limit the peer group in step 76 to include only medical professionals that operate in a similar class of patient treatment (Class 1, Class 2, . . ., Class N). In this way, the method 70 may ensure that the peer group 40 identified for the medical care provider 12 is narrowly tailored to ensure that the medical care provider 12 is only compared to medical professionals practicing under similar conditions. Once the peer group 40 is identified for the medical care provider 12, the method 70 may continue by outputting the peer group 40, identifying patient data 16 included in the peer group 40, and communicating the information to the factor identification module 34 (78).

Referring now to FIG. 4, a process diagram of method 80 for identifying the input scoring factors 54 is shown. As previously discussed, the factor identification module 34 may access the one or more information databases 38 to retrieve patient data 16 including a variety of the care factors 46. Accordingly, the factor identification module 34 of the system 30 may begin the method 80 by accessing the patient data 16 comprising the care factors 46 (82). Additionally, the factor identification module 34 may receive an identification of the peer group 40 from the provider classification module 32 (84). Accordingly, when the factor identification module 34 accesses one of more information databases 38, the patient data 16 and corresponding care factors 46 may be accessed for patients treated by medical professionals in the peer group 40. In this way, the patient data 16 retrieved by the factor identification module 34 may be limited to the patient data 16 of patients in the peer group 40 thereby improving the comparison of the care factors 46 for the medical care provider 12.

The filtering of the care factors 18 may be processed by a plurality of filtering steps, including the variation filtering 48 and provider correlation filtering 50. The variation filtering 48 may initially filter the patient data 16 and associated care factors 46 that do not have enough variation to significantly contribute to provider score 20 of the medical care provider 12. In some embodiments, the method 80 may apply the variation filtering 48 in step 86 by calculating a coefficient of variation (CV) of each of the care factors 46. The coefficient of variation may be calculated as the standard deviation of each of the care factors 46 divided by the mean of the care factors 46. Once the coefficient of variation is calculated for each of the care factors 46, the care factors 46 that have variation below a predetermined threshold or variation value may be filtered or removed from the input scoring factors 54 considered when calculating the provider score 20. In some embodiments, the predetermined threshold for the coefficient of variation may be 0.2 or 1.2. In this way, the care factors 46 demonstrating sufficient variation among the sampled patient data for the patient group 42 may pass the variation filtering 48 of step 86.

Following the variation filtering 48 of step 86, the method 80 may continue by applying the provider correlation filtering 50 (88). The provider correlation filtering 50 may be applied to the patient data 16 to identify the care factors 46 that can be attributed to the treatment or provider effect of the medical care provider 12. For example, the provider correlation filtering 50 may include calculating an interclass correlation coefficient (ICC) for each medical professional in the peer group 40. The interclass correlation coefficient may identify the amount of variation of each of the care factors 46 that can be attributed to the actions of the medical professionals in the peer group 40 as opposed to intrinsic factors that may be outside the control of the medical professionals in the peer group 40. In this way, the method 80 may limit the input scoring factors 54 to the care factors 46 related to the care provided by the medical professionals in the peer group 40. Accordingly, the method 80 may improve a processing efficiency and accuracy of the provider scoring module 22 by limiting noise, data, and care factors 46 that may otherwise result in calculation errors and increased processing time to identify the provider score 20.

The provider care factors 46 that are processed and filtered by the factor identification module 34 may include a wide variety of factors, which, in combination, may provide for an accurate estimation of the input scoring factors 54. The provider care factors 46 may comprise a plurality of financial factors 46a, quality factors 46b, and/or socioeconomic factors 46c. Financial factors 46a may include a wide variety of factors comprising laboratory costs, medication costs, outpatient costs, and/or inpatient costs. Each of these financial factors 46a may be analyzed independently such that the correlation of the activities of the medical professionals in the peer group 40 is individually attributed to differing financial factors 46a. The quality factors 46b may comprise a plurality of health metrics that may be utilized to identify the health level of patients in the patient group 42. For example, as previously discussed, the provider classification 14 of the medical care provider 12 may be endocrinology. Accordingly, the quality factors 46b for the patient group 42 may comprise HbA1c levels, lipid levels, and/or microalbumin levels. Accordingly, quality factors 46b may be included in the provider care factors 46 based on a provider classification 14 and the patient group 42.

The provider care factors 46 may further comprise socioeconomic factors 46c. The socioeconomic factors 46c may be particularly valuable in identifying aspects of the patient group 42 that are outside the control of the medical care provider 12. For example, patients in the patient group 42 that have low income, are lacking insurance, have low dietary quality, limited literacy rate, and/or lower education levels may considerably contribute to a decline in the quality factors 46b and corresponding increases in the financial factors 46a. Accordingly, by considering the socioeconomic factors 46c, particularly when calculating the ICC in the provider correlation filtering 50, the method 80 may improve in accuracy determination of the input scoring factors 54. In this way, the method 80 may utilize the socioeconomic factors 46c to ensure that the provider score 20 of the medical care provider 12 is not penalized or artificially decreased due to the medical care provider 12 practicing in a low income area or an area comprising patients who may not have access to proper dietary nutrition or other factors that may significantly impact their health.

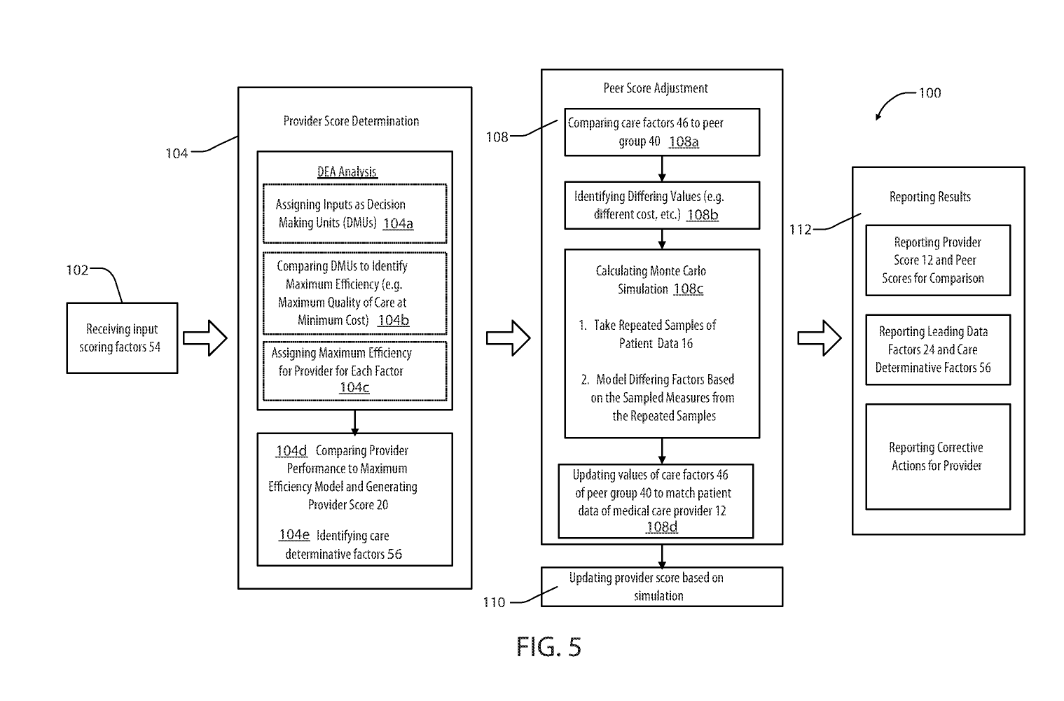

After applying the variation filtering 48 and provider correlation filtering 50, the method 80 may further provide for a step of incorporating the provider care factors 46 or the custom data inclusion 52 (90). As previously discussed, the factors for the custom data inclusion 52 may include factors that were filtered in the filtering steps 48 and 50, but may be of interest when assessing the provider score 20. Accordingly, the method 80 may incorporate additional factors in step 90 for the custom data inclusion 52 in order to ensure that specific factors are considered and incorporated in the input scoring factors 54, which may further be output from the factor identification module 34 and step 92. The input scoring factors 54 may then be supplied to the provider scoring module 22, as further discussed in FIG. 5.

Referring now to FIG. 5, a flowchart demonstrating a method 100 for calculating the provider score 20 based on the input scoring factors 54 is shown. In step 102, the method 100 may begin by receiving the input scoring factors 54 with the provider scoring module 22. With the input scoring factors 54, the provider scoring module 22 may continue the method 100 by utilizing DEA (104). DEA of step 104 may comprise a number of steps. For example, DEA may begin by assigning the input scoring factors 54 (104a). The provider scoring module 22 may then continue by comparing decision making units (e.g. the care providers) to identify a maximum efficiency comprising a balance between the quality of care factors 46b and the financial factors 46a (104b). Once the maximum efficiency or optimum care performance is identified, the method 100 may continue by assigning the maximum efficiency or a maximum efficiency value for each of the input scoring factors 54 (104c). Once the maximum efficiency for each of the input scoring factors 54 is identified, the provider scoring module 22 may continue by comparing patient and performance data for the medical care provider 12 to a maximum efficiency model for each of the input scoring factors 54 and generating the provider score 20 (104d). The maximum efficiency model may describe an optimum care performance balancing quality and cost of patient care for the medical care provider 12.

From DEA in step 104, a raw provider score may be calculated by a provider scoring module 22. Additionally, the maximum efficiency model from DEA may indicate that some of the input scoring factors 54 may be less important in identifying an optimum performance criteria or optimum output efficiency describing an objective balance between the financial factors 46a and the quality factors 46b. Accordingly, DEA may further be utilized by provider scoring module 22 to identify a plurality of care determinative factors 106 that may be identified as the leading data factors 24 affecting the balance of the results of the financial factors 46a and the quality factors 46b. In this way, DEA in step 104 may be processed by the provider scoring module 22 to objectively identify the highest score for each of the care determinative factors 106 in order to assess the medical care provider 12.

Following DEA in step 104, the method 100 may continue by performing a peer score adjustment (108). The peer score adjustment in step 108 may comprise comparing the values of the provider care factors 46 for the care provider 12 to other medical professionals in the peer group 40 (108a). Based on the comparison, the score adjusting module 36 may continue by identifying provider care factors 46 with differing values (108b). Next, in order to adjust for the differing values 108b, the score adjusting module 36 may apply a non-linear simulation (e.g., Monte Carlo simulation) to the patient data 16 in order to adjust for differences between the differing values 108b of the provider care factors 46 of the care provider 12 and the other medical professionals in the peer group 40 (108c). The Monte Carlo simulation in step 108c may include taking repeated samples of the patient data 16 and modeling the values of the care factors 46 that differ between the care provider 12 and the other medical professionals in the peer group 40 to determine how they affect the provider care factors 46. In this way, Monte Carlo simulation 108c may continue the method by generating simulated values or simulated patient data for the provider care factors 46 (108d). The simulated values may be generated for the provider care factors 46 having differing values for the medical professionals in the peer group 40 in order to have the differing values match those associated with the medical care provider 12 (108d). The simulation may update the differing values of the provider care factors 46 by modeling a non-linear distribution of the patient data 16 simulating an outcome of the differing care factor values based on the patient data 16 associated with the care provider 12.

With the values of the provider care factors 46 updated for the medical professionals in the peer group 40, the method 100 may continue by adjusting or analyzing the provider score 20 based on the Monte Carlo simulation 108c. The provider score 20 may then be output from the score adjusting module 36 to the data output and reporting module 58 (112). The data output and reporting module 58 may then report the provider score 20 as well as the input scoring factors 54 to the reporting interface 60. The provider score 20 as well as the input scoring factors 54 may then be analyzed by those assessing the medical care provider 12 in order to identify the performance of the medical care provider 12 in comparison to the other medical professionals in the peer group 40.

The Monte Carlo simulation is described herein as being applied to adjust the provider score 20 and may more specifically be applied to further examine the data utilized to generate the provider score 20. By examining the data utilized to generate the provider score 20, the Monte Carlo simulation may be applied to ensure that the provider score 20 is calculated based on data that similarly impacts the results for other medical professionals in the peer group 40. For example, the Monte Carlo may be applied to analyze the data for the provider care factors 46 utilized to generate the provider score 20 in comparison with the data for the provider care factors 46 of the other medical professionals in the peer group 40. Based on the analysis and/or comparison, the Monte Carlo simulation may be applied to simulate results from the data for the provider care factors 46 that allow the provider score 20 to accurately reflect the influence the medical care provider 12 has on the quality of patient care. In other words, the Monte Carlo simulation may be applied to the data for the care factors 46 for the medical care provider 12 and the professionals in the peer group 40 to adjust for differences in the care factors (e.g. socioeconomic factors 46c) to ensure that extrinsic factors outside the control of the care provider 12 do not inflate or adversely influence the provider score 20.

Accordingly, the provider score 20 may be adjusted based on the Monte Carlo simulation to limit variation in scoring due to extrinsic factors that may not be attributable to the quality of care provided by the medical care provider 12. In this way, the disclosure provides for a system and method to generate an unbiased score indicating a quality of care provided by the medical care provider 12 that is based on a comparison of the peer group 40 operating not only in a similar field of specialty but also having similar patients in similar socioeconomic conditions. Such accuracy, both in correlation to the medical care provider's actions as well as being based on similar extrinsic circumstances, has not previously been provided by an assessment method for medical care providers. Accordingly, the methods and systems discussed herein provide for optimum steps to provide specific processes to accurately identify a provider score for the medical care provider.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer readable storage medium, as used herein, is not to be construed as being transitory signals, per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language, such as Smalltalk, C++, or the like, and procedural programming languages, such as the “C” programming language, or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry, including, for example, programmable logic circuitry, field-programmable gate arrays (FPGA), or programmable logic arrays (PLA), may execute the computer readable program instructions by utilizing state information of the computer readable program instructions to personalize the electronic circuitry in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of assessing provider care metrics for use in a healthcare analytics management system, the method comprising:
identifying a medical care provider for performance review of a care term;
generating a classification for the provider indicating a peer group;
receiving, by a processor, class patient data associated with the classification, the class patient data comprising a plurality of care factors;
identifying, by the processor, care determinative factors from the plurality of care factors;
calculating, by the processor, an optimum care performance for the provider balancing a care cost and a care quality for the care determinative factors;
comparing, by the processor, a provider performance of the medical care provider during the care term to the optimum care performance; and
generating, by the processor, a provider score indicating a comparison of the provider performance to the peer group.

2. The method according to claim 1, wherein calculating the optimum care performance, by the processor, comprises processing a linear comparison of sample values from the patient data thereby determining an optimum performance balancing the quality and the cost for each of the care determinative factors.

3. The method according to claim 2, wherein the linear comparison comprises processing, by the processor, a Data Envelopment Analysis (DEA) of the care determinative factors.

4. The method according to claim 3, wherein the DEA comprises comparing the patient data for each of the care determinative factors as a plurality of inputs and generating a plurality of optimum performance criteria for the care determinative factors.

5. The method according to claim 4, wherein the optimum performance criteria comprises a plurality of values for the care determinative factors providing an optimum output efficiency balancing a cost and a quality.

6. The method according to claim 5, wherein the comparing the provider performance of the medical care provider comprises comparing, by the processor, the optimum performance criteria to the provider performance for each of the care determinative factors and generating a provider score.

7. The method according to claim 1, further comprising:
reporting, by the processor, the provider score via a reporting interface; and
based on the provider score, making an administrative determination based on the provider score.

8. The method according to claim 7, wherein the administrative determination comprises assigning a training requirement for the medical care provider based on the provider score, wherein the training requirement relates to one of the care determinative factors.

9. A computer program product for identifying a comparative level of patient care for a care provider, the computer program product comprising a computer readable storage medium having program instructions embodied therewith, the program instructions are executable by a processor to cause the processor to:
generate a classification with the processor for the care provider indicating a peer group, wherein the peer group identifies a medical specialty field in which the care provider practices;
receive class patient data associated with the classification, the class patient data comprising a plurality of care factors, wherein the plurality of care factors comprise care factor values quantifying the care factors for each of a plurality of patients of the patient data;
identify care determinative factors from the plurality of care factors;
calculate an optimum care performance for the provider balancing a care cost and a care quality for the care determinative factors;
compare, by the processor, a provider performance of the medical care provider during the care term to the optimum care performance; and
generate, by the processor, a provider score indicating a comparison of the provider performance to the peer group.

10. The computer program product according to claim 9, wherein the program instructions further cause the processor to:
identify one or more of a plurality of differing care factor values for the care factors that differ between the class patient data associated with the classification and a plurality of provider patient data associated with provider.

11. The computer program product according to claim 9, wherein the program instructions further cause the processor to:
simulate a simulated class patient data based on a simulation for the class patient data adjusting each of the care factors having the differing care factor values.

12. The computer program product according to claim 11, wherein the simulation comprises a non-linear simulation.

13. The computer program product according to claim 11, wherein the simulation comprises a Monte Carlo simulation.

14. The computer program product according to claim 13, wherein the Monte Carlo simulation comprises repeatedly sampling the class patient data and modeling the non-linear distribution of the patient data thereby simulating an outcome of the differing care factor values based on the class patient data.

15. The computer program product according to claim 11, wherein the program instructions further cause the processor to:
adjust the provider score based on the simulated class patient data thereby ensuring that the provider score is evaluated based on like conditions of the care determinative factors.

16. A method of assessing provider care metrics for use in a healthcare analytics management system, the method comprising:
identifying a medical care provider for performance review of a care term;
generating a classification for the medical care provider indicating a peer group;
receiving, by a processor, class patient data associated with the classification, the class patient data comprising a plurality of care factors;
identifying, by the processor, care determinative factors from the plurality of care factors, wherein the identifying of the care determinative factors comprises:
variation filtering the care factors, by the processor, based on a minimum variation generating first filtered factors; and
correlation filtering the care factors, by the processor, based on a correlation between the plurality of care factors and at least one activity attributed to the medical care provider generating care determinative factors; and
calculating, by the processor, an optimum care performance for the provider balancing a care cost and a care quality for the care determinative factors.

17. The method according to claim 16, wherein the minimum variation is calculated as a coefficient of variation for each of the plurality of care factors.

18. The method according to claim 17, wherein the care factors are passed to the correlation filtering as the first filtered factors in response to the coefficient of variation for the plurality of care factors being greater than a predetermined variation value.

19. The method according to claim 16, wherein the correlation filtering comprises calculating, by the processor, an interclass correlation coefficient of the first filtered factors for each of a plurality of sample care providers in the peer group.

20. The method according to claim 16, wherein the correlation filtering comprises estimating, by the processor, care provider variation attributed to activities of the sample care providers.
